(19) United States
(12) Patent Application Publication
(10) Pub. No.: US 2013/0173063 A1
(43) Pub. Date: Jul. 4, 2013

(54) METHOD FOR CONTROLLING A COMPRESSOR

(71) Applicant: Georg Winkes, Kaarst (DE)

(72) Inventor: Georg Winkes, Kaarst (DE)

(21) Appl. No.: 13/820,812

(22) PCT Filed: Sep. 9, 2011
(86) PCT No.: PCT/EP2011/065662

§ 371 Date: Mar. 5, 2013

(30) Foreign Application Priority Data
Sep. 9, 2010 (DE) 102010040503.5

(51) Int. Cl. G05B 15/02

(52) U.S. Cl. CPC G05B 15/02
USPC 700/275

(57) ABSTRACT

A compressor includes a control unit and a model unit. The control unit determines at least two actuation values of at least two actuating elements of the compressor via a transmitted setpoint value of a parameter of the compressor from a characteristic diagram of the compressor or at least two corrected actuation values of the at least two actuating elements via a model-based theoretical setpoint value from the characteristic diagram of the compressor. The model unit determines a model-based theoretical state of the compressor via the actuation values or the corrected actuation values by using a state model of the compressor. The model-based theoretical state of the compressor is described at least with the model-based theoretical setpoint value of the parameter of the compressor. The control unit controls at least one of the actuating elements as a function of the corrected actuation value of this actuating element.

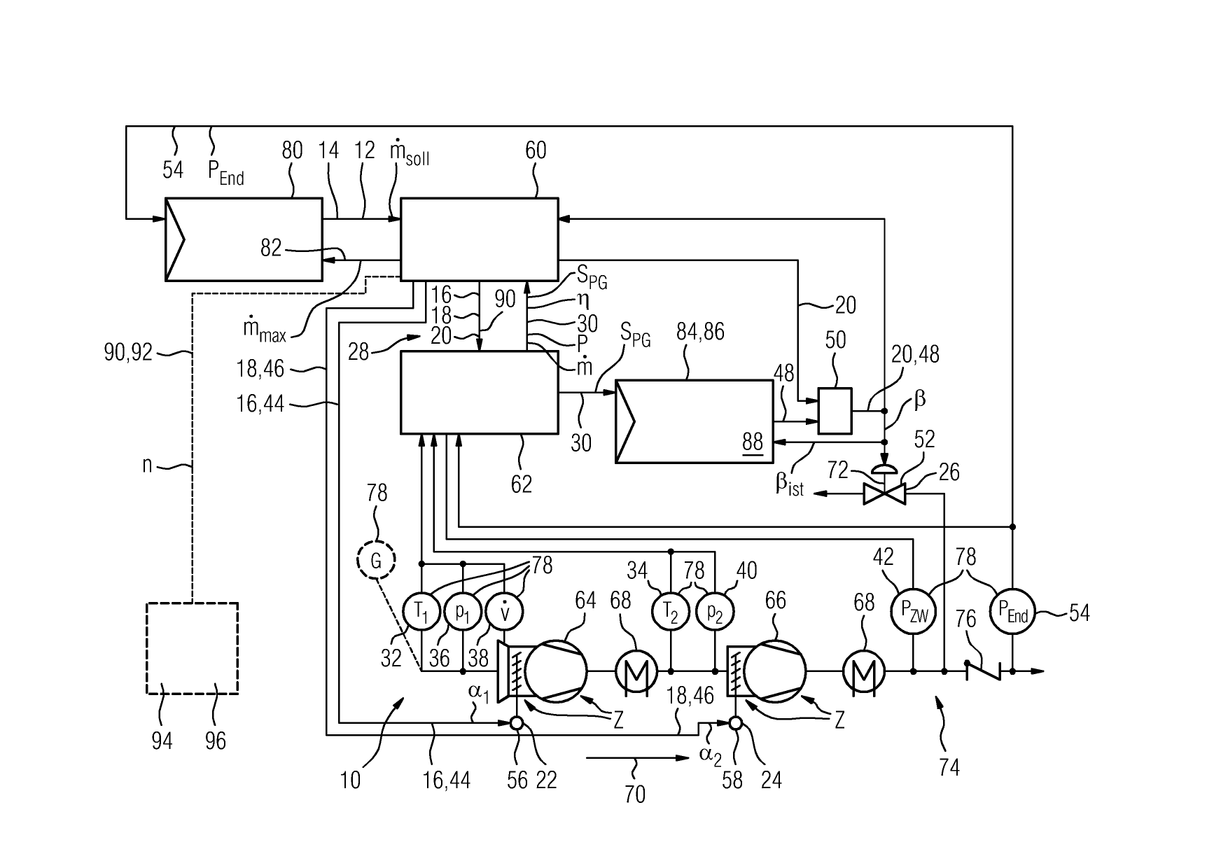

### CROSS REFERENCE TO RELATED APPLICATIONS

This application is the US National Stage of International Application No. PCT/EP2011/065662, filed Sep. 9, 2011 and claims the benefit thereof. The International Application claims the benefits of German application No. 10 2010 040 503.5 DE filed Sep. 9, 2010. All of the applications are incorporated by reference herein in their entirety.

### FIELD OF INVENTION

The invention relates to a method for controlling a compressor.

### BACKGROUND OF INVENTION

Compressors for providing compressed gas for industrial purposes are usually controlled by means of one or more characteristic diagrams. DE 195 06 790 A discloses such a method for controlling a compressor in which actual values of the compressor are measured by means of sensors of the compressor, and the isentropic compressor work and the input volume stream are determined from these measured values and a predefined value for the throughput rate. Efficiency-adapted actuation values for the angle settings of the guiding apparatuses during the operation of the compressor are adapted incrementally by using a characteristic diagram stored in a computer.

EP 1 069 314 A1 discloses a compressor controller. EP 1 069 314 A1 proposes for this purpose preparing a setpoint value, for example for a mass flow of the compressor. Two actuation values, for example an angle of a row of inlet guide vanes and a setting value for a valve stroke, are determined therefrom on the basis of two characteristic diagrams of the compressor. The actuation/control of the compressor or the adjustment of the row of inlet guide vanes and of the valve of the compressor are then carried out by means of these two actuation values as setpoint values of two regulators.

US 2009/0274565 A1 discloses a method for controlling a compressor in which current measured values for three parameters of the compressor are determined. Working points of the compressor are determined on the basis of three characteristic diagrams of the compressor, each characteristic diagram describing the relationship between two of these parameters.

### SUMMARY OF INVENTION

An object of the present invention is to provide a controller of a compressor with which good efficiency is achieved.

The object is achieved by the features of the independent claim(s). Favorable refinements and advantages of the invention can be found in the further claims, the drawing and the description.

The invention is based on a method for controlling a compressor. According to the invention the method comprises the following steps:

a provision of at least one setpoint value of a parameter of the compressor,

b determination of at least two actuation values of at least two actuating elements of the compressor by means of the setpoint value,

c determination of a model-based theoretical state of the compressor by means of the actuation values,

d iterative correction of at least one of the actuation values as a function of the theoretical state, and

e control of at least one of the actuating elements by means of an actuation value.

Good efficiency and a large operation range of the compressor can be advantageously achieved by means of the embodiment according to the invention. In addition, energy consumption can be kept low, which reduces costs.

In this context, a “compressor” is to be understood as any compressor which appears appropriate to a person skilled in the art such as, for example, a motor-operated, in particular multi-stage compressor with intermediate cooling and a constant rotational speed and/or a turbine-operated geared compressor or single-shaft compressor.

A “setpoint value” constitutes here, in particular, a power request to the compressor which is to be taken into account in the determination of the actuation values and, in particular, aimed at. It is also possible that the setpoint value contains a further request, or some other request, such as, for example, a distance from a pump limit, a minimum load of individual gearbox components such as, for example, pinion shafts of the compressor, compliance with the absorption limit of individual stages of the compressor, compliance with the total power of the compressor below a maximum power level of the compressor and/or some other request which appears expedient to a person skilled in the art. These requirements can be permanently stored in the controller of the compressor and/or fed in from the outside. The setpoint value can be predefined by a control means or an operator and therefore provided, wherein the control means can be part of a compressor or an external means.

A “parameter” is to be understood here, in particular, as meaning a final temperature, a final pressure, an efficiency value, an energy consumption value, a volume flow, a mass flow and in particular, an effective mass flow and/or some other parameter which appears expedient to a person skilled in the art and/or a quotient of an absolute value of a parameter and a limiting value of that parameter, wherein the “limiting value” is a maximum or minimum value at which the compressor can still be operated reliably.

The actuation values of the actuating elements are expediently transferred from a data memory, for example from a characteristic diagram, or calculated. They may each specify a state of an actuating element, for example a position of a valve or the like, wherein the state is generally not the current state of the respective actuating element but instead a setpoint state which can be obtained from the predefined setpoint value.

The determination of the actuation values on the basis of the setpoint value is preferably carried out by means of a control unit which can apply for this any determination or calculation method and/or optimization algorithm which appears appropriate to a person skilled in the art, such as, for example, the downhill simplex method, the gradient method, the quasi-Newton method and/or particularly preferably the numeric method of sequential quadratic programming In this context, the setpoint value which is to be complied with is transferred to the method as a secondary condition. The determined actuation values are transmitted from the control unit to a model unit. Determination of more than two actuation values of more than two actuating elements would also be generally conceivable here. The actuation values and the actuating elements may be different or identical parameters or components which are embodied differently or the same way. For the sake of simplicity, only actuation values and actuating elements will be referred to below. A “model-based theoretical state” constitutes here, in particular, a state which is determined by means of a computational model of the model unit and, in particular, by means of a thermodynamic model.

In order to determine the theoretical state, a behavior of the compressor is advantageously simulated. In this context, the model unit expediently uses the transmitted actuation values to calculate, by means of the thermodynamic model, how a state of the compressor would be if these actuation values were set at the actuating elements and the compressor were to be operated with the said parameters. As a result, a behavior of the compressor can be determined independently of direct changes at the compressor in a way which does not place stress on the equipment and is reliable in terms of processors. In addition, fluctuations in a delivery quantity during operation can be advantageously prevented.

In addition, during the determination of the theoretical state the behavior of the compressor is incrementally adapted to the setpoint value in a control loop. In this context, a “control loop” is understood to be, in addition to strictly target-oriented determination of the state, a determination which occurs in an undirected and/or diffuse way and/or also “the wrong way round” and/or, in particular, according to a numerical method of the sequential quadratic programming The control loop is preferably located between the control unit and the model unit. If, for example, the model unit then supplies the information of the determined theoretical state or an assigned parameter to the control unit, the latter determines actuation values again therefrom in the event of a predetermined deviation of the parameter from the setpoint value. These actuation values are transmitted again to the model unit for renewed calculation of the theoretical state of the behavior of the compressor under the new conditions. In the case of determination and modification of the actuation values by means of a numerical method of sequential quadratic programming, this takes place in a way which is known to a person skilled in the art. The implementation of the control loop permits fine adjustment of the actuation values to take place particularly effectively and easily.

At least one of the actuating elements is preferably not actuated with an actuation value until a parameter of the theoretical state corresponding to the setpoint value reaches a predefined proximity to the setpoint value. In this context, the term “a predefined proximity to the setpoint value” is to be understood, in particular, as meaning that a value is stored in the control unit and/or a value can be determined by said control unit which defines an acceptable amount of deviation of the parameter from the setpoint value and/or constitutes an abort condition which relates to a speed of a reduction in an optimization function of the method. A person skilled in the art expediently selects the value of the predefined proximity in a way which is adapted to the method and/or the parameters of the compressor used. As a result, disadvantageous or even damaging operation of the compressor can be prevented in a way which saves resources.

In a further embodiment of the invention, there is provision that at least one actual value of the state of the compressor is included in the determination of the model-based theoretical state. In this context, an “actual value of the state of the compressor” is understood, in particular, as meaning a measured and/or instantaneous or current state value of the compressor such as, for example, a pressure, a volume flow, a temperature and/or some other state value which appears appropriate to a person skilled in the art and which is in a time window of less than 60 seconds, or preferably less than 30 seconds and particularly advantageously less than 10 seconds from the time of the determination. A temperature, and particularly preferably at least two temperatures, is/are included in the calculation and/or in the thermodynamic model, and in particular an input temperature or a measured suction temperature of the compressor or a first stage of the compressor and a measured recooling temperature of the compressor and/or of the first stage which corresponds to a suction temperature of at least one second stage of the compressor. The determination of the state by means of an actual value and, in particular, by means of a temperature allows the state to be determined particularly easily and with lower expenditure.

In addition it is proposed that the determined model-based theoretical state be corrected by means of at least one further actual value of the state of the compressor. This further actual value preferably constitutes at least one pressure and/or a volume flow and, in particular, a measured suction pressure of the first stage and/or of the second stage and/or a measured intermediate pressure and/or a measured volume flow. However, any other actual value which appears applicable to a person skilled in the art would generally also be conceivable. The thermodynamic model preferably adjusts the determination of the theoretical state continuously by means of these further measured actual values, as a result of which the real actual state of the compressor is included as currently and precisely in the state prediction as is possible. As a result, the compressor can be controlled in a way which is particularly precisely adjusted to the actual state of the compressor. Furthermore, it may be advantageous if, when at least one predetermined state is present, at least one of the actuating elements is actuated directly by means of at least one uncorrected actuation value, by bypassing the model-based correction. In this context, a “predetermined state” is to be understood, in particular as meaning a state of the compressor in which a determination of the theoretical state by means of the model unit or the thermodynamic model would last too long, such as, for example, a dynamic change in a final pressure of the compressor and/or a rapid increase in the setpoint value. An “uncorrected actuation value” is to be understood here, in particular, as meaning an actuation value which has been determined independently of the thermodynamic model. The uncorrected actuation value may be independent of the setpoint value. The embodiment according to the invention can provide a way of controlling the compressor which is particularly reliable and safe.

In addition it is proposed that the predetermined state be a critical state of the compressor which is placed in an uncritical state by the direct actuation of at least one of the actuating elements. In this context, a “critical state” is to be understood, in particular, as meaning a state in which the compressor is operated above a predetermined load limit and/or during the operation of which there is a risk of damage to the compressor and/or the individual stages of the compressor. Consequently, an “uncritical state” is a state in which the compressor operates below the load limit. In particular, in the critical state the actuation values determined from the setpoint value or the determined actuation value for the actual state of the compressor are not adapted or are no longer suitable for the actual state. “Direct actuation” is to be understood here, in particular, as meaning direct actuation without intermediate determination of the theoretical state. Direct actuation permits process-reliable control to be implemented, and therefore a reliable way of controlling a compressor to be advantageously devised.

A preferred development comprises combining at least one actuation value which is corrected as a function of the theoretical state and at least one uncorrected actuation value by means of at least one comparator. The comparator receives the at least one corrected actuation value from the control unit and the at least one uncorrected actuation value from a safety device, such as, for example, a pump limit regulator. A decision about the direct actuation of an actuating element which is acted on can be implemented in a structurally simple way by means of the comparator.

It is also proposed that at least one valve is actuated with at least one of the uncorrected actuation values. The valve is preferably a continuously adjustable valve and particularly preferably a regulating valve. By means of the valve it is possible to change over from the critical state into the uncritical state quickly and in a structurally simple way.

Furthermore, it is proposed that the predetermined state comprise changing the setpoint value above a defined setpoint value gradient. In this context, the term “changing of the setpoint value above a defined setpoint value gradient” is to be understood, in particular, as meaning that the change in the setpoint value and/or in the actual value of time occurs so quickly that the determination of the actuation value by means of the setpoint value using the optimization algorithm is incapable of reacting, or is not in a position to react quickly enough, to this change. This value depends on a processing speed of the control unit and is, for example, 0.5%/s. As a result it is possible to ensure that bypassing of the model-based correction is triggered only in the case of severe changes in the setpoint value. In addition it is advantageous if the direct actuation of at least one of the actuating elements brings about more rapid adaptation of an actual value of the compressor to the setpoint value than by means of the model-based correction. The actual value is preferably a final pressure of the compressor, but can in principle be any other actual value which is considered to be usable by a person skilled in the art. This direct actuation takes place by means of the control unit and by means of at least one uncorrected actuation value determined there. As a result, a mode of control can be provided which operates independently of the model calculation and therefore predicatively passes on a preliminary, still uncorrected actuation value in order to adapt a state of the compressor quickly to a new setpoint value and therefore improve a working result of the compressor.

The compressor is expediently regulated, and the setpoint value used as a regulation variable. In this context, the regulation preferably takes place by means of a process regulator such as, for example, a final pressure regulator and/or any other regulator which appears expedient to a person skilled in the art. The compressor can be controlled in a particularly easy way by means of the embodiment according to the invention.

Furthermore it is proposed that an actuation value is at least an attitude angle of at least one guiding device of the compressor and/or a position of a valve. In this context, more than one guiding device or a plurality of guiding devices is/are preferably supplied with an actuation value or with a plurality of actuation values, wherein each guiding device can be controlled with the same actuation value or with different actuation values. Generally, a group of guiding devices can also be supplied with the same actuation value, and a second group can be supplied with another actuation value. It is particularly advantageous in the case of a compressor with more than two stages to supply each guiding device of each stage with an actuation value which differs from another actuation value of another guiding device. In this context it is preferred if the number of guiding devices is smaller than or equal to the number of stages of the compressor. By means of the adjustment of the guiding devices, a free cross section of the compressor can be changed in a structurally easy way and/or swirling of a flow of a fluid of the compressor can be avoided, as a result of which a delivered fluid quantity of the compressor can be advantageously modulated. In addition, a pressure and/or a fluid quantity in the compressor can be changed quickly and structurally easily by the valve.

It would basically also be conceivable to vary the rotation speed of the compressor. Adapted value tables of characteristic diagrams must be stored in the model unit for this purpose. As a result, for example in the case of a two-stage compressor, three degrees of freedom could be reached, which advantageously increases the variation possibilities.

It is therefore advantageous if an actuation value is a position of a valve and/or a rotation speed of the compressor. Consequently it can also be advantageous if an actuation value is at least one attitude angle of at least one guiding device of the compressor and/or a rotational speed of the compressor and/or a position of a valve. If a plurality of guiding devices is then provided, preferably in corresponding to the number of stages of the compressor, it may also be advantageous if the actuation values are a plurality of actuation angles (αₙ) of a plurality of guiding devices of the compressor and/or a rotational speed of the compressor and/or a position of a valve.

A further embodiment of the invention provides that a gas composition is measured and is taken into account in the determination of the model-based theoretical state, as a result of which the determination or the thermodynamic model can be approximated to operation with a nonideal gas or to a gas used by, for example, including a real gas equation. Basically, it would however, also be possible to input the gas composition into the control unit by means of numerical values which are included in the determination by the model unit, and/or given the presence of at least one constant compressor field it would be conceivable to determine the gas composition by means of at least one actual value or by means of measured measuring variables and the pressure conditions which the stages produce.

The invention is also based on a compressor having a control unit and a model unit.

It is proposed that the control unit is provided for determining at least two actuation values of at least two actuating elements of the compressor by means of a transmitted setpoint value of a parameter of the compressor, and that the model unit is provided for determining a model-based theoretical state of the compressor by means of the actuation values, and that the control unit is provided for correcting at least one of the actuation values as a function of the theoretical state, and for controlling at least one of the actuating elements by means of an actuation value. As a result of this embodiment it is possible to implement an optimum efficiency level of the compressor, with equal emphasis on minimum energy consumption.

In addition it would be possible to adapt the determination of the model-based theoretical state or the thermodynamic model to a polytropic flow work and/or a polyltropic efficiency level in a manner known to a person skilled in the art.

### BRIEF DESCRIPTION OF THE DRAWINGS

The invention will be explained in more detail with reference to an exemplary embodiment which is illustrated in the drawing.

### DETAILED DESCRIPTION OF INVENTION

The single FIGURE of the drawing shows a schematic illustration of a compressor 10 in the form of a two-stage motor-operated geared compressor with a controller according to the invention. The compressor 10 has a plurality Z and/or a first stage 64 and a second stage 66, each of which have connected downstream a heat exchanger 68, for example for intermediate cooling. In addition, an actuating element 22, 24 in the form of a guiding device 56, 58 is arranged at each stage 64, 66, by means of which guiding device 56, 58 an attitude angle α₁, α₂ of blades of the guide devices 56, 58 can be changed or set. As a result, the number Z of stages corresponds to a number Z of the guiding devices 56, 58. Arranged downstream of the heat exchanger 68 of the second stage 66 in the flow direction 70 of a working fluid (not illustrated in more detail), such as, for example, a gas, in the process is a valve 52 in the form of a regulating valve 72, by means of whose position β the discharging of the fluid can be adjusted.

In addition, a nonreturn valve 76 is arranged at the end of the compressor chain 74, which nonreturn valve 76 separates the compressor 10 from a further system (not shown here). The valve 52 is open before and during the starting of the compressor 10, and the fluid can escape, as a result of which in the compressor 10 there is a low pressure. If a pressure which is above the pressure of the compressor 10 is present in the further system, the nonreturn valve 76 is kept closed. If the pressure in the compressor 10 then rises as a result of powering up of the compressor 10 and the closing of the valve 52 and if the pressure exceeds a characteristic curve of the nonreturn valve 76, the latter is opened and the fluid can escape.

Furthermore, a plurality of measuring elements 78, for example in the form of temperature measuring sensors, pressure transmitters and through-flow transmitters, for measuring actual values 32, 34, 36, 38, 40, 42, 54 are arranged in the compressor chain 74. As a result, an actual value 32 of a suction temperature T₁, an actual value 36 of a suction pressure p₁ and an actual value 38 of a suction-side volume flow V are determined in the flow direction 70 upstream of the first stage 64 here. An actual value 34 of the suction temperature T₂ and an actual value 40 of a suction pressure p₂ are measured upstream of the second stage 66. In addition, downstream of the second stage 66 and upstream of the nonreturn valve 76 an actual value 42 of an intermediate pressure p_{zw} is determined, and downstream of the nonreturn valve 76 an actual value 54 of a final pressure p_{End} is determined

In addition, the compressor 10 has a control unit 60 and a model unit 62 which operate a method for controlling the compressor 10. In this context, a setpoint value 12 of a parameter 14 of the compressor 10 such as, for example, a mass flow \dot{m}, and therefore \dot{m}ₛₑₚₜ is transmitted to the control unit 60. This is carried out by a process regulator 80 in the form of a final pressure regulator which has calculated the setpoint value 12 from the actual value 54 of the final pressure p_{End} fed to it, as a result of which the compressor 10 is regulated and the setpoint value 12 is used as a regulation variable. In addition, the process regulator 80 receives a maximum value 82 of the parameter 14, here \dot{m}ₘₐₓ, from the control unit 60. If the setpoint value 12 is above the maximum value 82, the latter is sent as a setpoint value 12 to the control unit 60.

The control unit 60 then determines three actuation values 16, 18, 20 of the actuating elements 22, 24, 26 and/or of the guiding devices 56, 58 and of the valve 52 of the compressor 10 by means of the setpoint value 12. This determination takes place in a way which is known to the person skilled in the art by means of a numerical algorithm which is stored in the control unit 60 in the form of sequential quadratic programming These three determined actuation values 16, 18, 20 are then transmitted to the model unit 62 which determines a model-based theoretical state of the compressor 10 by means of the actuation values 16, 18, 20, wherein a behavior of the compressor 10 is simulated in order to determine the theoretical state (computational model, see below).

This model-based theoretical state or predicted parameters 30 assigned thereto, for example of an efficiency level η, of an energy consumption level P, of a distance from a pump limit S_{PG} or a mass flow \dot{m} is sent to the control unit 60. In this context, just one parameter 30 or preferably a plurality of different parameters 30 can be sent to the control unit 60; for the sake of simplicity just one parameter 30 is treated here. The control unit 60 compares the parameter 30 or the determined mass flow \dot{m} with the setpoint value 12 and in the event of a deviation of the values from one another corrects the actuation values 16, 18, 20 as a function of the theoretical state by means of the numerical method. In addition, it compares the parameter 30 with further requirements such as a distance from the pump limit S_{PG}, a minimum load of individual pinion shafts of the compressor 10, compliance with the absorption limit of the stages 64, 66, maintaining overall power of the compressor 10 below a maximum power level of the compressor 10 and, if appropriate, adapts the actuation values 16, 18, 20 thereto. These requirements can be stored in the control unit 60 and/or fed in from the outside. The corrected actuation values 16, 18, 20 are sent again to the model unit 62 for the determination of the model-based theoretical state. As a result, the behavior of the compressor 10 is incrementally adapted to the setpoint value 12 as in a control loop 28 between the control unit 60 and the model unit 62.

The actuating elements 22, 24, 26 are not controlled by means of the actuation values 16, 18, 20 corrected as a function of the theoretical state until the parameter 30 of the theoretical state corresponding to the setpoint value 12 has a reached a predefined proximity from the setpoint value 12. In this context, the actuation values 16, 18 are attitude angles α₁, α₂ of the guiding devices 56, 58 of the compressor 10, and the actuation value 20 is the position β of the valve 52.

The control therefore takes place by means of interaction of the thermodynamic model and the numerical algorithm. During the operation of the compressor 10, scenarios are therefore sent to the thermodynamic model or the model unit 62 continuously by varying the three actuation values 16, 18, 20 and α₁, α₂ and β by means of the control unit 60. The thermodynamic model determines and then feeds back what theoretical state would occur, referred, for example, to the mass flow \dot{m}, the efficiency level η or the energy consumption level P, when these actuation values 16, 18, 20 are used. It is therefore possible to determine how, while preserving a total delivery quantity, these three actuation values 16, 18, 20 would have to change for the energy consumption level P to be, for example, as small as possible.

The thermodynamic model determines the effectively delivered mass flow \dot{m}_{eff}. The following prior considerations are necessary for this:

A molar mass of the delivered fluid and a rotational speed of the compressor 10 are assumed to be constant. A total increase πges in pressure of the compressor 10 is composed of the pressure ratios π1, π2 of the individual stages 64, 66 and can be determined according to

$${π}_{ges} = {\prod }_{i = 1}^{n} {π}_{i}$$

Here, the apportionment to the individual stages 64, 66 is to be determined in such a way that a drive line assumes a minimum value. A total energy consumption level P of the compressor 10 is determined from:

$${P}_{k , Stage} = \frac{{e}_{s}}{{η}_{k , s}} m ,$$

where eₛ is the specific isentropic flow work. The efficiency level η_{k,s} includes both losses of the isentropic change in state, further flow losses and mechanical losses, for example of a gearbox. The specific isentropic flow work can be described as eₛᵢ=f(αᵢ, φᵢ) and the efficiency level as η_{s,ki}f=(αᵢ, φᵢ). The throughflow coefficient φ is proportional to the suction-side volume flow \dot{V} given a constant rotational speed, as a result of which eₛ₁=f(α₁, \dot{V}₁) and η_{s,ki}=f(α₁, \dot{V}₁) are obtained. These functional relationships of the individual stages 64, 66 are stored as values which are calculated in advance and corrected by means of testing, in 2-dimensional value tables. Basically, these tables could also be changed or improved in the method.

In order to determine the energy consumption P, the effective mass flow \dot{m}_{eff} must then be calculated. The latter is determined from \dot{m}_{eff}=f(p₁, T₁, T₂, α₁, α₂, p_{zw}, β). This can be derived as follows:

A suction pressure p₂ of the second stage 66 is dependent on the suction pressure p₁ and the pressure ratio π₁ of the first stage 64:

$${p}_{2} = {p}_{1} {π}_{1} , \\ where$$

$${π}_{1} = {[ 1 + \frac{{e}_{s 1}}{\frac{κ}{κ - 1} {RT}_{1}} ]}^{\frac{κ}{κ - 1}} and$$

$${e}_{s 1} = f ( {α}_{1} , {ϕ}_{1} ) is .$$

Correspondingly, it is apparent with respect to the intermediate pressure p_{zw} that the latter is dependent on the suction pressure p₂ and the pressure ratio π₂ of the second stage 66 is:

$${p}_{zw} = {p}_{2} {π}_{2} , \\ wherein$$

$${π}_{2} = {[ 1 + \frac{{e}_{s 2}}{\frac{κ}{κ - 1} {RT}_{2}} ]}^{\frac{κ}{κ - 1}} and$$

$${e}_{s 2} = f ( {α}_{2} , {ρ}_{2} ) = f ( {α}_{2} , {\dot{V}}_{2} ) , {\dot{V}}_{2} \approx {\dot{V}}_{1} \frac{{p}_{1} {T}_{2}}{{p}_{2} {T}_{1}}$$

From this it is possible to generalize that

p_{zw}=f(p₁,T₁,T₂,α₁,α₂,V₁).

If the compressor 10 then delivers a pressure-side volume, the pressure in this volume changes if a balance of a quantity which is fed in and/or discharged remains unequalized. The intermediate pressure p_{zw} of the compressor 10 is obtained by integrating the mass flow balance, as a result of which

\dot{m}=f(p₁,T₁,T₂,α₁,α₂,p_{zw})

is obtained. If a mass flow \dot{m} downstream of the nonreturn valve 76 is then considered, the position β and therefore the quantity of fluid which is blown around and/or blown out can be taken into account, and the following is obtained:

\dot{m}_{eff}=f(p₁,T₁,T₂,α₁,α₂,p_{zw},β)

The actuation values 16, 18, 20, the attitude angle α₁ and α₂ and the position β can be influenced by the actuating elements 22, 24, 26. T₁, T₂, p₁ and p_{zw} constitute interference variables which depend on outer peripheral conditions. The suction pressure p₁ can usually be assumed to be constant. The intermediate pressure p_{zw} can be determined by the above-described calculable dependence on the other values. As a result, two actual values 32, 34 of the state of the compressor 10 and the measured suction temperatures T₁ and T₂ of the two stages 64, 66 are included in the determination of the model-based theoretical state by means of the thermodynamic model. The model can determine the model-based theoretical state solely with knowledge of these two actual values 32, 34. However, the determined model-based theoretical state is also corrected by means of further actual values 36, 38, 40, 42 of the state of the compressor 10 and by means of the measured suction pressures p₁, p₂, the measured intermediate pressure p_{zw}, and the measured volume flow \dot{V}.

In addition, the compressor 10 has a safety device 84 in the form of a pump limit regulator 86. The pump limit regulator 86 continuously determines whether a distance from the pump limit S_{PG} is complied with. For this purpose, it receives from the model unit 60 the parameter 30 of the distance from the pump limit S_{PG} which is determined theoretically in said model unit 60, and it compares the latter with a setpoint value 88 which is stored in the pump limit regulator 86. If the parameter 30 approaches a range with, for example, 7%-10% deviation from the setpoint value 88 or if it undershoots the latter, both which can occur, for example, in the case of dynamic change of the pressure in the compressor 10, the pump limit regulator 86 is activated. It then determines, by means of a PI algorithm, an uncorrected actuation value 48 and/or a position β of the valve 52 at which the distance from the pump limit S_{PG} is complied with. This uncorrected actuation value 48 is sent to a comparator 50 which additionally receives from the control unit 60 the actuation value 20 which is corrected as a function of the theoretical state. The comparator 50 then determines, by comparison of the actuation values 20, 48, which actuation value brings about a relatively large open position of the valve 52 and passes on this actuation value 20, 48 determined in this way to the valve 52 in order to control the latter. When the pump limit regulator 86 engages, it is, for example, the uncorrected actuation value 48.

As a result, when a predetermined state, such as a critical state of a rapid change in pressure, is present in the compressor 10, the actuating element 26 or the valve 52 is actuated directly by means of the uncorrected actuation value 48, by bypassing the model-based correction, as a result of which the compressor 10 is changed to an uncritical state and is not operated at its load limit. The pump limit regulator 86 is disengaged again if the thermodynamic model has reacted to the change in pressure by adaptation of its predictions.

During the operation of the compressor 10 by means of the theoretical determination of the actuation values 16, 18, 20, the comparator 50 sends the actuation value 20 to the valve 52. In this context, a resulting actuation value βᵢₛₜ for the position β of the valve 52 is submitted to the pump limit regulator 86, with the result that the latter can be adjusted according to this actual actuation value βᵢₛₜ.

The thermodynamic model therefore has two functions, on the one hand that of the theoretical prediction of the state by means of the calculation with assumed actuation values 16, 18, 20 and, on the other hand, that of regulating the compressor 10 by means of the pump limit regulator 86.

Likewise, when a predetermined state occurs in the form of a change in the setpoint value 12 above a defined setpoint value gradient, the actuating elements 22, 24, 26 are actuated directly by means of uncorrected actuation values 44, 46, 48 by bypassing the model-based correction. In this context, this direct actuation of the actuating elements 22, 24, 26 brings about a more rapid adaptation of the actual values 34, 40, 42, 54 of the compressor 10 to the setpoint value 12 than by means of the model-based correction. In the case of a large jump in the setpoint value 12 during the model calculation of the model unit 62, the control unit 60 therefore determines, by means of a linearization, how the actuating elements 22, 24, 26 would have to be changed to be appropriate for the changed setpoint value 12.

A display of relevant actuation values, actual values, setpoint values, information about differences between these values and values which would have been reached without the model-based correction and/or summing, for example of the energy saving, can be made available indirectly to an operator via the compressor controller using a display unit (not illustrated here), as a result of which advantages of the system are advantageously apparent.

Also, in addition to the actuation values 16, 18, 20, an actuation value 90 in the form of a rotational speed n of an actuating element 94 (indicated only by dashed lines here) in the form of a motor 96 can be determined, corrected and set. In this case also, when a predetermined state is present, the actuating element 94 can be actuated directly by means of an uncorrected actuation value 92 by bypassing the model-based correction. Alternatively and/or additionally, a rotational speed of a turbine can also be set.

In addition, in the case of work for the compressor 10 with a variable gas composition G, the latter is measured with a measuring element 78 which is shown only by dashed lines in the figure and taken into account in the determination of the model-based theoretical state. Alternatively, it is possible to dispense with the process regulator 80, wherein the setpoint value 12 is also fed to the system from the outside here in other ways. In addition, in one alternative embodiment, the pump limit regulator 86 and the comparator 50 can also be dispensed with if the calculation of the optimized actuation values 16, 18, 20 takes place quickly enough in order to react adequately even in the case of sudden process changes.

The exemplary embodiment describes the method in exemplary fashion for a two-stage compressor with a change in state of the internal pressure. In principle, the model can be applied to any multi-stage compressor. In the thermodynamic model, it is also possible to use polytropic variables instead of isentropic flow work values or efficiency levels. Furthermore, other representations of the compressor characteristic diagram which permit calculation of power and delivery quantity by means of the given input variables can also be used.

1-15. (canceled)

16. A method for controlling a compressor, comprising the steps of:
a) providing at least one setpoint value of a parameter of the compressor,
b) determining at least two actuation values of at least two actuating elements of the compressor via the provided setpoint value from a characteristic diagram of the compressor,
c) determining model-based theoretical state of the compressor via the actuation values by using a state model of the compressor, wherein the model-based theoretical state of the compressor is described at least with a model-based theoretical setpoint value of the parameter of the compressor,
d) determining at least two corrected actuation values at the at least two actuating elements via the model-based theoretical setpoint value from the characteristic diagram of the compressor,
e) performing an iterative correction by iteratively repeating the steps c) and d) until the model-based theoretical setpoint value determined in the respective iteration has a specific degree of proximity to the provided setpoint value,
f) controlling at least one of the actuating elements as a function of the actuation value, corrected in the last iteration, of this actuating element.

17. The method as claimed in claim 16, wherein in order to determine the theoretical state a behavior of the compressor is simulated, wherein the behavior is incrementally adapted to the provided setpoint value in a control loop.

18. The method as claimed in claim 16, wherein at least one of the actuating elements is not actuated with an actuation value until the model-based theoretical setpoint value determined in the respective iteration reaches a specific degree of proximity to the provided setpoint value.

19. The method as claimed in claim 16, comprising including at least one actual value of the state of the compressor in the determination of the model-based theoretical state.

20. The method as claimed in claim 19, further comprising correcting the determined model-based theoretical state via at least one further actual value of the state of the compressor.

21. The method as claimed in claim 16, further comprising directly actuating at least one of the actuating elements via at least one uncorrected actuation value, by bypassing the model-based correction, when at least one predetermined state is present.

22. The method as claimed in claim 21, wherein the predetermined state is a critical state of the compressor which is placed in an uncritical state by the direct actuation of at least one of the actuating elements.

23. The method as claimed in claim 21, further comprising combining at least one actuation value which is corrected as a function of the theoretical state and at least one uncorrected actuation value, via at least one comparator.

24. The method as claimed in claim 21, further comprising actuating at least one valve with at least one of the uncorrected actuation values.

25. The method as claimed in claim 16, wherein the predetermined state comprises changing the provided setpoint value above a defined setpoint value gradient and the direct actuation of at least one of the actuating elements brings about more rapid adaptation of an actual value of the compressor to the provided setpoint value than by means of the model-based correction.

26. The method as claimed in claim 16, further comprising regulating the compressor, and using the provided setpoint value as a regulation variable.

27. The method as claimed in claim 16, wherein an actuation value is at least one attitude angle of at least one guiding device of the compressor and/or a position of a valve.

28. The method as claimed in claim 16, wherein the actuation values are a plurality of attitude angles of a plurality of guiding devices of the compressor and/or a rotational speed of the compressor and/or a position of a valve.

29. The method as claimed in claim 16, wherein a gas composition is measured and is taken into account in the determination of the model-based theoretical state.

30. A compressor, comprising:
a control unit for determining at least two actuation values of at least two actuating elements of the compressor via a transmitted setpoint value of a parameter of the compressor from a characteristic diagram of the compressor or at least two corrected actuation values of the at least two actuating elements via a model-based theoretical setpoint value from the characteristic diagram of the compressor, and
a model unit for determining a model-based theoretical state of the compressor via the actuation values or the corrected actuation values by using a state model of the compressor, wherein the model-based theoretical state of the compressor is described at least with the model-based theoretical setpoint value of the parameter of the compressor,
wherein the control unit is configured for controlling at least one of the actuating elements as a function of the corrected actuation value of this actuating element.
